(19) United States
(12) Patent Application Publication
(10) Pub. No.: US 2014/0020923 A1
(43) Pub. Date: Jan. 23, 2014

(54) PNEUMATIC TOOL

(71) Applicant: Basso Industry Corp., Taichung (TW)

(72) Inventor: San-Yih Su, Taichung (TW)

(21) Appl. No.: 13/944,325

(22) Filed: Jul. 17, 2013

(30) Foreign Application Priority Data
Jul. 18, 2012 (TW) 101125824

(51) Int. Cl. B25B 21/00

(52) U.S. Cl. CPC B25B 21/00
USPC 173/218

(57) ABSTRACT

A pneumatic tool includes a shell body with an air-feeding path, a cylinder including first and second air passages, a rotary valve, and a valve control component. The rotary valve has an intermediate air passage, and is rotatable among first, second and third angular positions to control airflows from the air-feeding passage to the first and second air passages, so as to control output power of the pneumatic tool. The valve control component is disposed on the shell body and is operable by an external force to bring the rotary valve into rotation among the first, second and third angular positions.

### CROSS-REFERENCE TO RELATED APPLICATION

This application claims priority to Taiwanese Application No. 101125824, filed on Jul. 18, 2012.

### BACKGROUND OF THE INVENTION

1. Field of the Invention

The invention relates to a pneumatic tool, and more particularly to a pneumatic tool with a power regulation feature. 2. Description of the Related Art

Referring to FIG. 1, U.S. Pat. No. 5,293,747 discloses a conventional pneumatic tool 1 that includes a shell body 11, a cylinder 12 disposed in the shell body 11, a reversing valve 13 and a control valve 14. The shell body 11 has an air-feeding passage 111 and an air-discharging passage 112 for control of airflow, and a regulation passage 113. The cylinder 12 is disposed in the shell body 11, and has an air-motor portion 121, a first passage 123 in fluid communication with the air-feeding passage 111 and the regulation passage 113, and a second passage 124 in fluid communication with the air-discharging passage 112. The reversing valve 13 is used for guiding air to flow into the first passage 123 or the second passage 124. The control valve 14 is used to close or open the regulation passage 113.

When the control valve 14 closes the regulation passage 113, the air fully flows into the air-motor portion 121 of the cylinder 12 for generating power. On the other hand, when the control valve 14 opens the regulation passage 113, the reversing valve 13 guides the air to flow from the air-feeding passage 111 into the first passage 123, with a portion of the air entering the regulation passage 113 before entering the air-motor portion 121 of the cylinder 12, so that the power generated by the conventional pneumatic tool 1 is relatively small. In this manner, power regulation can be implemented.

Since the reversing valve 13 and the regulation passage 113 are formed outside of the cylinder 12, the shell body 11 must be big enough for containing the reversing valve 13 and the regulation passage 113 therein, resulting in difficulty in reduction of product size. In addition, it is difficult to use the control valve 14 for precise control of power variation through adjustment of cross-sectional area for air discharge (i.e., open/close the regulation passage 113). Furthermore, since a great amount of air enters the air-motor portion 121, it is hard to obtain a small power output.

There are also pneumatic tools that regulate power through adjustment of cross-sectional area for air feed-in. However, when the desired power output is small, the cross-sectional area for air feed-in must be small enough, which may increase pressure at the air-feeding position, and result in difficulty of power control and operation of the pneumatic tool (e.g., high pressure may make it difficult to press a trigger of the pneumatic tool).

### SUMMARY OF THE INVENTION

Therefore, an object of the present invention is to provide a pneumatic tool that enables relatively good control of power regulation while having a relatively small size.

According to the present invention, a pneumatic tool comprises:
a shell body formed with an air-feeding path;
a cylinder disposed in the shell body, and including a cylinder wall that extends along an X-axis direction to form an air chamber, a valve seat that is connected to the cylinder wall and that is spatially communicated with the air chamber, and first and second air passages each formed in the cylinder wall and configured to be spatially communicated with the air chamber through the valve seat;
a rotary valve extending through the valve seat, and having an intermediate air passage spatially inter-communicating the air-feeding path and at least one of the first and second air passages, the rotary valve being operable to rotate among a first angular position at which the intermediate air passage spatially inter-communicates the air-feeding path and the first air passage, a second angular position at which the intermediate air passage spatially inter-communicates the air-feeding path and the second air passage, and a third angular position at which the intermediate air passage spatially inter-communicates the air-feeding path and both of the first and second air passages; and a valve control component disposed on the shell body and operable by an external force to bring the rotary valve into rotation.

### BRIEF DESCRIPTION OF THE DRAWINGS

Other features and advantages of the present invention will become apparent in the following detailed description of the preferred embodiments with reference to the accompanying drawings, of which:

FIG. 1 is a sectional view illustrating a conventional pneumatic tool disclosed in U.S. Pat. No. 5,293,747;

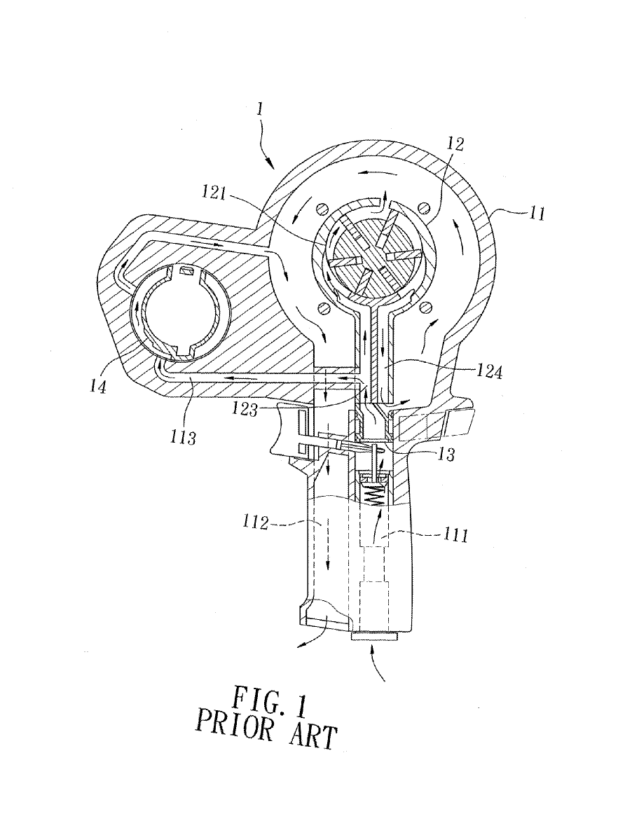

FIG. 2 is an exploded perspective view illustrating a first preferred embodiment of a pneumatic tool according to the present invention;

FIG. 3 is a rear view of the first preferred embodiment;

FIG. 4 is a sectional view of the first preferred embodiment taken along line IV-IV in FIG. 3;

FIG. 5 is a sectional view illustrating that a rotary valve of the first preferred embodiment is at a first angular position;

FIG. 6 is a sectional view of the first preferred embodiment taken along line VI-VI in FIG. 5;

FIG. 7 is a sectional view illustrating that the rotary valve of the first preferred embodiment is at a second angular position;

FIG. 8 is a sectional view of the first preferred embodiment taken along line VIII-VIII in FIG. 7;

FIG. 9 is a sectional view illustrating that the rotary valve of the first preferred embodiment is at a third angular position;

FIG. 10 is a sectional view of the first preferred embodiment taken along line X-X in FIG. 9;

FIG. 11 is a sectional view illustrating a second preferred embodiment of a pneumatic tool according to the present invention; and

FIG. 12 is another sectional view of the second preferred embodiment.

### DETAILED DESCRIPTION OF THE PREFERRED EMBODIMENTS

Before the present invention is described in greater detail, it should be noted that like elements are denoted by the same reference numerals throughout the disclosure.

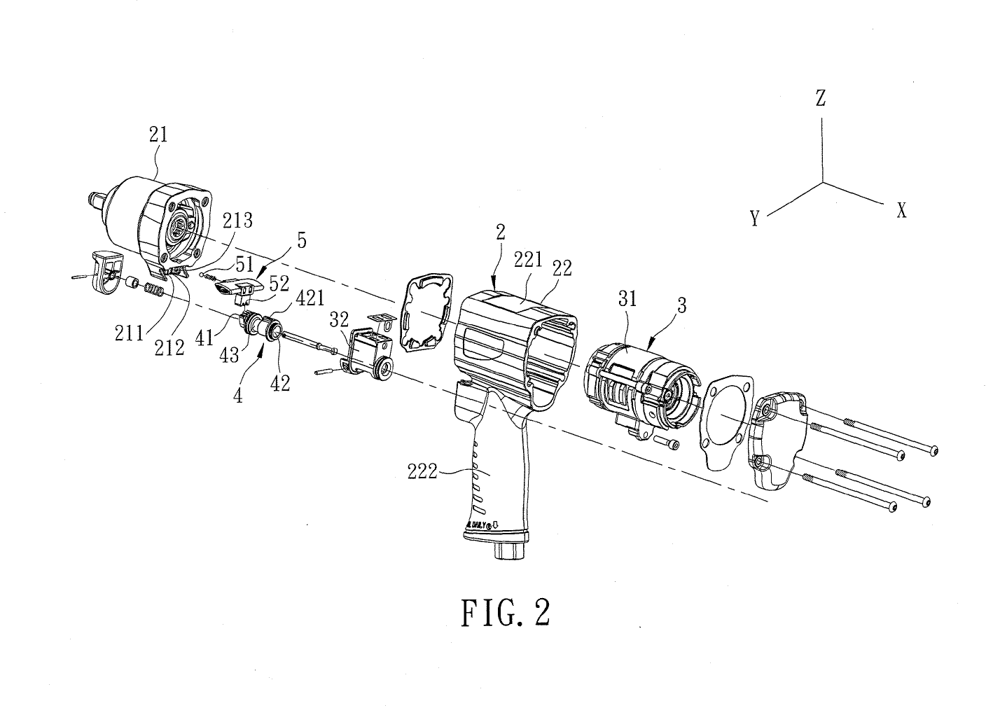

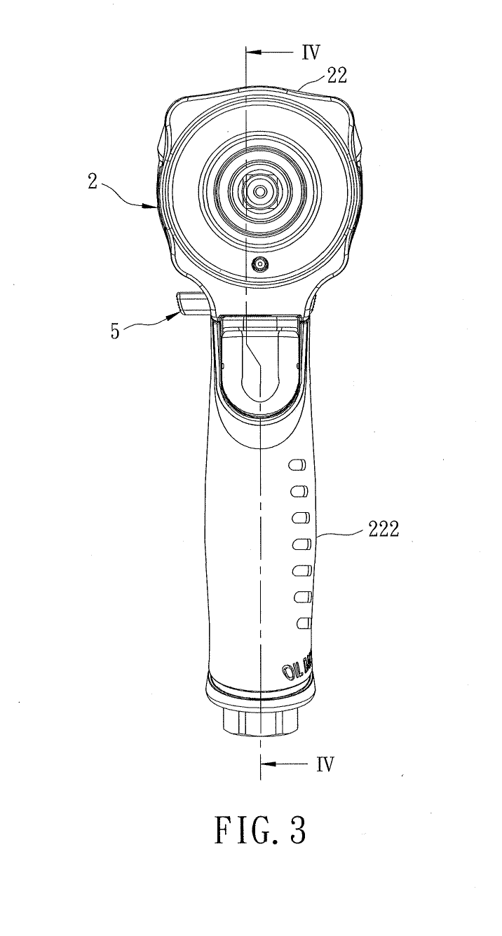

Referring to FIGS. 2 to 5, the first preferred embodiment of the pneumatic tool with a power regulation feature according to this invention is shown to include a shell body 2, a cylinder 3, a rotary valve 4 and a valve control component 5.

The shell body 2 includes a first seat 21 and a second seat 22 that are configured to be mounted together along an X-axis direction, i.e., a longitudinal direction of the cylinder 3. The first seat 21 is formed with first, second and third positioning portions 211, 212, 213 in a Y-axis direction transverse to the X-axis direction at a side facing the second seat 22. In this embodiment, each of the first, second and third positioning portions 211, 212, 213 is an indent. The second seat 22 has a shell cover 221, a grip 222 disposed adjacent to the shell cover 221 and extending along a Z-axis direction transverse to both of the X-axis and Y-axis directions, an exhausting passage 223 formed in the shell body 22, and an air-feeding path 224 formed in the grip 222 for receiving air from an air source (not shown). In this embodiment, the exhausting passage 223 extends along the Z-axis direction and passes through the grip 222.

The cylinder 3 is disposed in the second seat 22 of the shell body 2, and includes a cylinder wall 31 that extends along the X-axis direction to define an air chamber 30, a valve seat 32 that is connected to the cylinder wall 31 and that is spatially communicated with the air chamber 30, first and second air passages 33, 34 formed in a lower portion of the cylinder wall 31, at least an air-exiting port 35 formed at an upper portion of the cylinder wall 31, and a rotor 36 rotatably disposed in the air chamber 30. Each of the first and second air passages 33, 34 is configured to be spatially communicated with the air chamber 30 through the valve seat 32. The air-exiting port 35 spatially communicates the air chamber 30 with the outside.

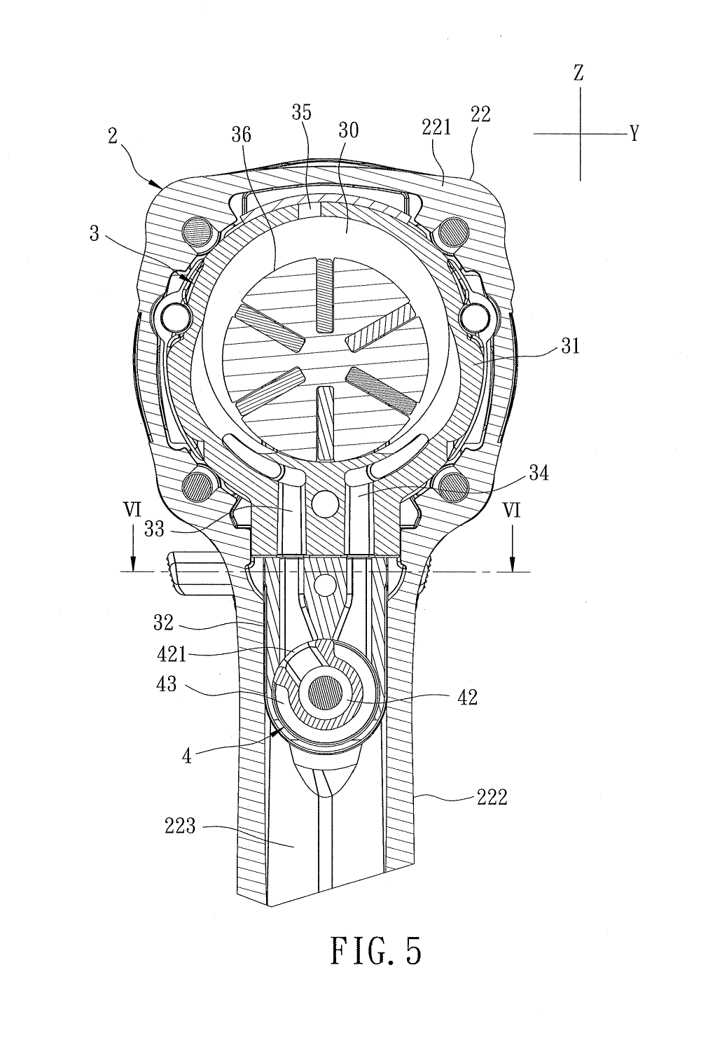

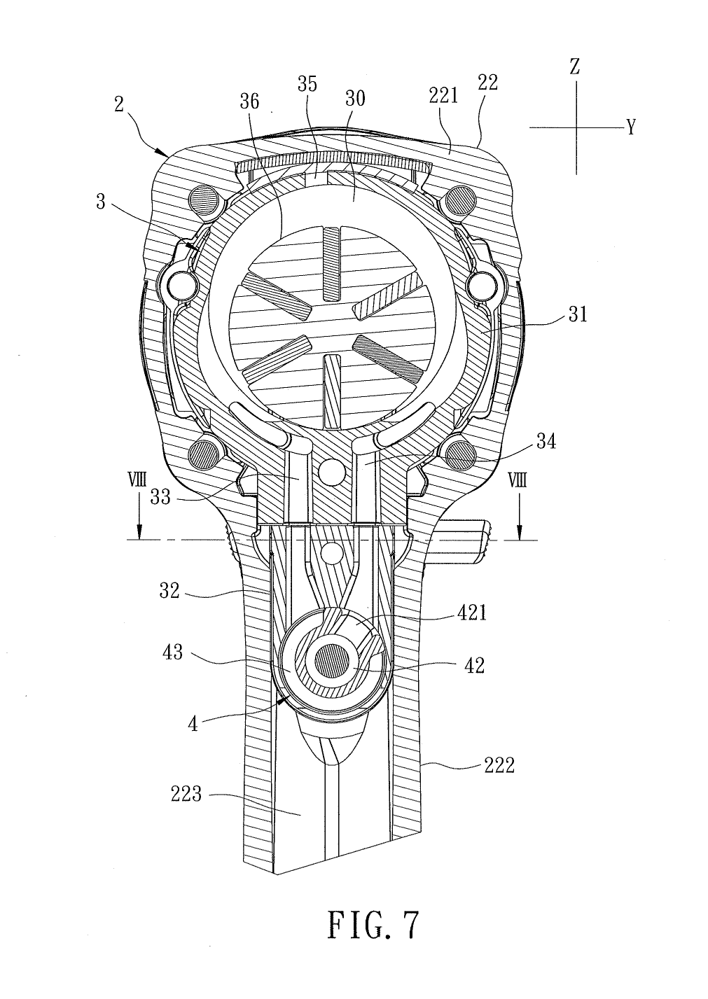

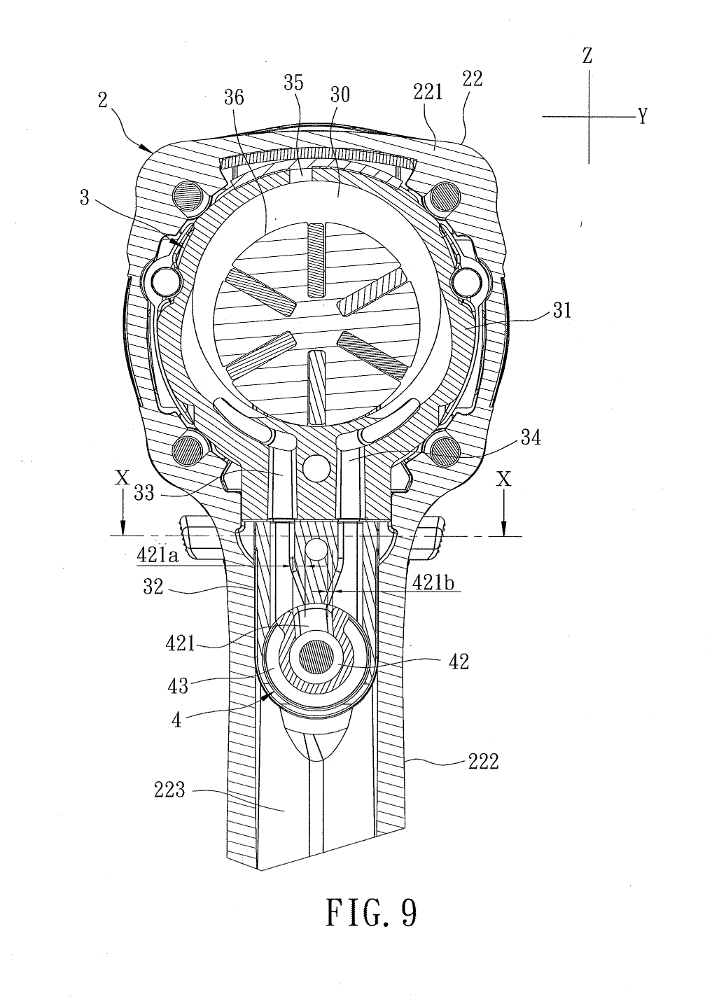

The rotary valve 4 is rotatable about a valve axis parallel to the X-axis direction, extends through the valve seat 32, and has a pinion portion 41 formed around the valve axis, an intermediate air passage 42 extending along the X-axis direction and spatially inter-communicating the air-feeding path 224 and at least one of the first and second air passages 33, 34, and a notch 43 formed around the valve axis and spatially communicated with the exhausting passage 223. The rotary valve 4 is operable to rotate among a first angular position at which the intermediate air passage 42 spatially inter-communicates the air-feeding path 224 and the first air passage 33 (as shown in FIG. 5), a second angular position at which the intermediate air passage 42 spatially inter-communicates the air-feeding path 224 and the second air passage 34 (as shown in FIG. 7), and a third angular position at which the intermediate air passage 42 spatially inter-communicates the air-feeding path 224 and both of the first and second air passages 33, 34 (as shown in FIG. 9). The intermediate air passage 42 has at least an air outlet 421, such that when the rotary valve 4 is at the third angular position, the air outlet 421 has a first portion 421a spatially inter-communicating the air-feeding path 224 and the first air passage 33, and a second portion 421b that is smaller than the first portion 421a in cross-sectional area, and that spatially inter-communicates the air-feeding path 224 and the second air passage 34.

The valve control component 5 extends movably through the shell cover 221 of the shell body 2 in the Y-axis direction, and is formed with an engagement portion 51 that is engaged with one of the positioning portions 211, 212, 213 of the shell body 2 at an outer surface thereof, and a rack portion 52 that is engaged with the pinion portion 41 of the rotary valve 4. In this embodiment, the engaging portion 51 of the valve control component 5 is a protrusion.

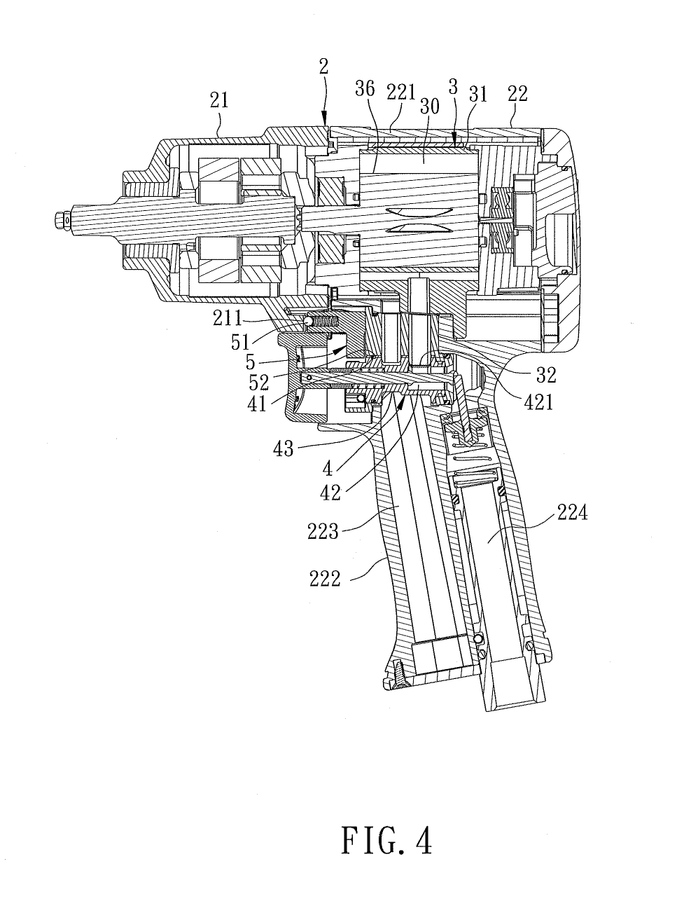

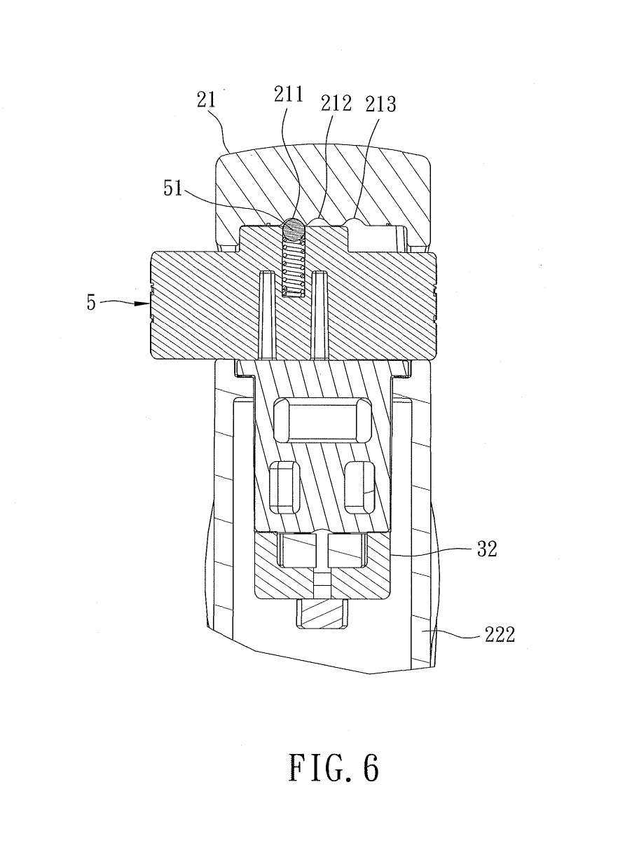

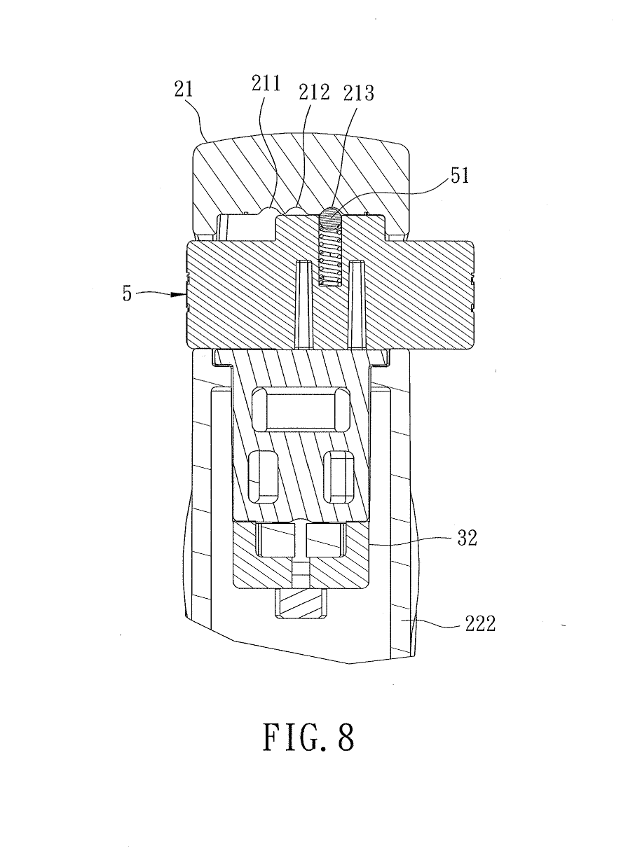

Referring to FIGS. 4 to 8, when the valve control component 5 is moved by a user along the Y-axis direction so that the engaging portion 51 is engaged with the first positioning portion 211 or the third positioning portion 213, the rotary valve 4 is thus rotated between the first angular position (see FIG. 5) and the second angular position (see FIG. 7) because of the engagement between the rack portion 52 of the valve control component 5 and the pinion portion 41 of the rotary valve 4 during the movement of the valve control component 5, so as to change rotation direction of the rotor 36 and provide maximum output power.

Therefore, the air will flow from the air-feeding path 224 into the air chamber 30 through only a corresponding one of the first air passage 33 and the second air passage 34, so as to provide maximum airflow to drive the rotor 36 to rotate in a corresponding direction, resulting in maximum output power.

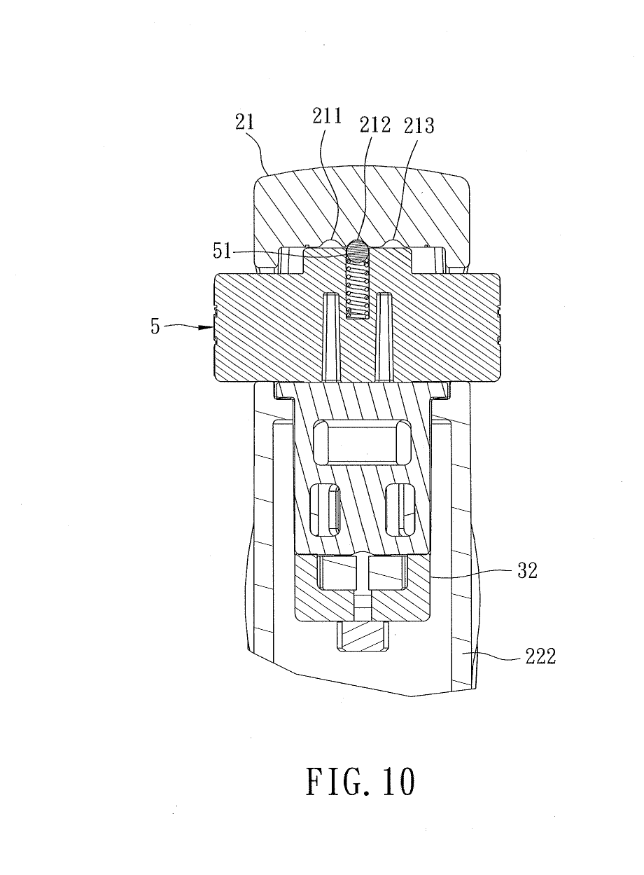

Referring to FIGS. 4, 9, and 10, when a smaller output power is desired, the valve control component 5 may be moved so that the engaging portion 51 is engaged with the second positioning portion 212, so as to rotate the rotary valve 4 to the third angular position (see FIG. 9).

At this time, a first airflow through the first air passage 33 is larger than a second airflow through the second air passage 34 since the first portion 421a of the air outlet 421 is larger than the second portion 421b of the air outlet 421 in cross-sectional area. When the first and second airflows interact in the air chamber 30, a torque generated from the first airflow will be weakened by a torque generated from the second airflow since the directions of the first and second airflows are different with respect to the rotor 36, thereby reducing the output power.

In addition, after the first airflow drives the rotor 36, it goes from a region with a higher pressure to a region with a lower pressure, and a portion thereof is discharged via the air-exiting port 35, so that the pressure of the first airflow is lowered. At this time, the pressure of the second airflow forms a back pressure, so as to weaken the torque generated from the first airflow. Then, the first airflow is discharged out of the cylinder 3 from the second air passage 34, passes through the notch 43, and is exhausted from the exhausting passage 223.

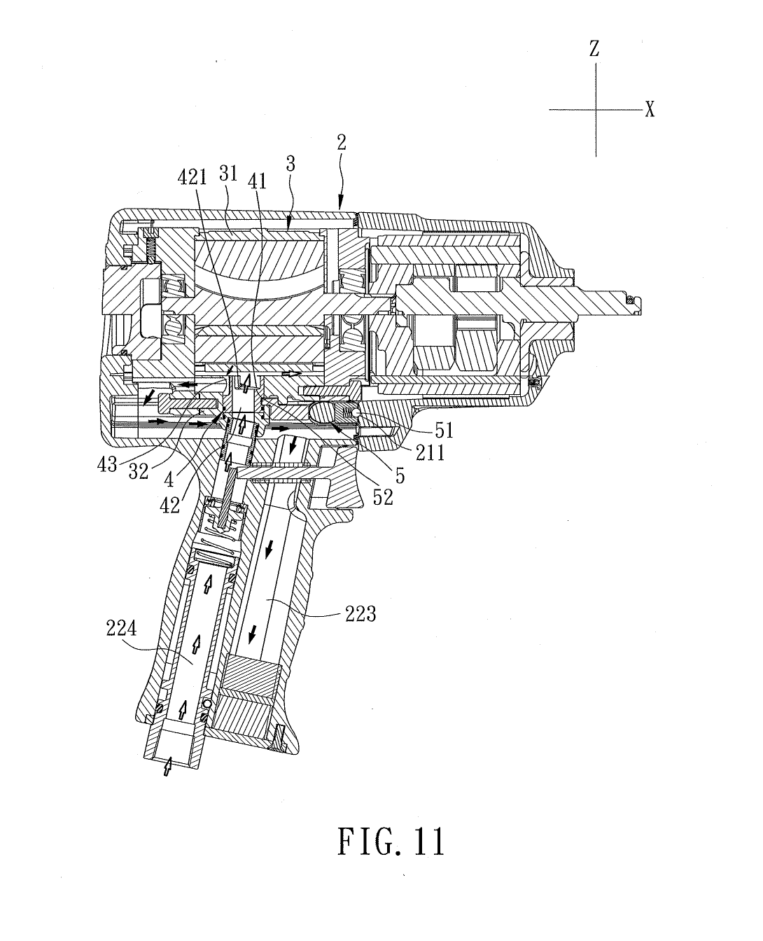

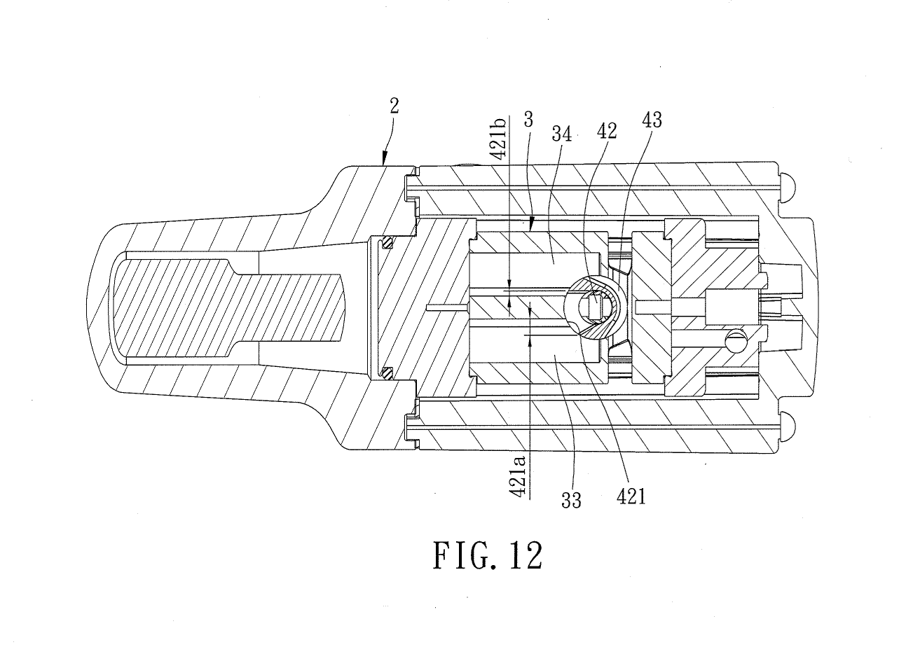

Referring to FIGS. 11 and 12, a second preferred embodiment of the pneumatic tool according to the present invention is shown to be similar to the first preferred embodiment. The second preferred embodiment differs from the first preferred embodiment in that the rotary valve 4 is rotatable about a valve axis parallel to the Z-axis direction, and the intermediate air passage 42 extends along the Z-axis direction.

To sum up, the pneumatic tool according to the present invention uses the opposite first and second airflows to obtain a weakened torque, has a relatively simple structure and is easy to operate. In addition, the output power is adjustable through the same action of changing rotation direction of the rotor 36 (i.e., pushing the valve control component 5), so as to facilitate user operation of the pneumatic tool.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A pneumatic tool comprising:
a shell body formed with an air-feeding path;
a cylinder disposed in said shell body, and including a cylinder wall that extends along an X-axis direction to form an air chamber, a valve seat that is connected to said cylinder wall and that is spatially communicated with said air chamber, and first and second air passages each formed in said cylinder wall and configured to be spatially communicated with said air chamber through said valve seat;
a rotary valve extending through said valve seat, and having an intermediate air passage spatially inter-communicating said air-feeding path and at least one of said first and second air passages, said rotary valve being operable to rotate among a first angular position at which said intermediate air passage spatially inter-communicates said air-feeding path and said first air passage, a second angular position at which said intermediate air passage spatially inter-communicates said air-feeding path and said second air passage, and a third angular position at which said intermediate air passage spatially inter-communicates said air-feeding path and both of said first and second air passages; and
a valve control component disposed on said shell body and operable by an external force to bring said rotary valve into rotation.

2. The pneumatic tool as claimed in claim 1, wherein said shell body has a plurality of positioning portions arranged in a Y-axis direction transverse to the X-axis direction, said valve control component extending through said shell body in the Y-axis direction, and being formed with an engagement portion at an outer surface thereof, said engagement portion being configured to be engaged with one of said positioning portions of said shell body; and
wherein said engagement portion is engageable with another one of said positioning portions when said valve control component is operated into movement by the external force in the Y-axis direction, so as to bring said rotary valve into rotation.

3. The pneumatic tool as claimed in claim 2, wherein each of said positioning portions of said shell body is an indent, and said engaging portion of said valve control component is a protrusion.

4. The pneumatic tool as claimed in claim 2, wherein said shell body includes a first seat formed with said positioning portions, and a second seat formed with said air-feeding path, said first and second seats being configured to be mounted together along the X-axis direction.

5. The pneumatic tool as claimed in claim 1, wherein said intermediate air passage has an air outlet, such that when said rotary valve is at the third angular position, said air outlet has a first portion spatially inter-communicating said air-feeding path and said first air passage, and a second portion that is smaller than said first portion in cross-sectional area, and that spatially inter-communicates said air-feeding path and said second air passage.

6. The pneumatic tool as claimed in claim 1, wherein said rotary valve is rotatable about an axis parallel to the X-axis direction, and has a pinion portion, said valve control component extending movably through said shell body in a Y-axis direction transverse to the X-axis direction, and being formed with a rack portion that is engaged with said pinion portion of said rotary valve.

7. The pneumatic tool as claimed in claim 6, wherein said shell body is further formed with an exhausting passage for exhausting air out of said pneumatic tool, said rotary valve being further formed with a notch in spatial communication with said exhausting passage, so as to exhaust air out of said pneumatic tool through said notch.

8. The pneumatic tool as claimed in claim 1, wherein said rotary valve is rotatable about an axis parallel to a Z-axis direction transverse to the X-axis direction, and is formed with a pinion portion, said valve control component extending movably through said shell body in a Y-axis direction transverse to both of the X-axis and Z-axis directions, and being formed with a rack portion that is engaged with said pinion portion of said rotary valve.

9. The pneumatic tool as claimed in claim 8, wherein said shell body is further formed with an exhausting passage for exhausting air out of said pneumatic tool, said rotary valve being further formed with a notch in spatial communication with said exhausting passage, so as to exhaust air out of said pneumatic tool through said notch.
